(19) United States
(12) Patent Application Publication
(10) Pub. No.: US 2026/0081690 A1
(43) Pub. Date: Mar. 19, 2026

(54) Two Dimensional Optical Phased Array Photonic Integrated Circuit Phase and Amplitude Vector Conjugation System for Multimode Fiber Applications

(71) Applicant: TAARA CONNECT, INC., Sunnyvale, CA (US)

(72) Inventors: Stephen Palese, Menlo Park, CA (US); Sanam Mozaffari, San Francisco, CA (US); Ondrej Cierny, San Francisco, CA (US); Paul Epp, Sunnyvale, CA (US)

(21) Appl. No.: 19/290,665

(22) Filed: Aug. 5, 2025

Related U.S. Application Data
(60) Provisional application No. 63/696,396, filed on Sep. 19, 2024.

(51) Int. Cl. H04B 10/2507; H04B 10/2581

(52) U.S. Cl. CPC H04B 10/2507; H04B 10/2581

(57) ABSTRACT

Aspects of the disclosure provide a device and method of adjusting received signals to correct for errors resulting from mode mixing in a multimode fiber using an optical phased array (OPA) photonic integrated circuit (PIC) based device. The method including receiving, at an OPA PIC, a first signal from the multimode fiber; receiving, at the OPA PIC, a plurality of control wavelengths, wherein each of the plurality of control wavelengths is encoded with a distinct spatial mode and wherein the first signal and the plurality of control wavelengths are co-propagating signals; determining, by one or more processors of the OPA PIC, a cross-coupling matrix based on the plurality of control wavelengths, the cross-coupling matrix being indicative of errors in the first signal; and adjusting, by the one or more processors of the OPA PIC, the first signal based on the cross-coupling matrix.

### CROSS REFERENCE TO RELATED APPLICATIONS

The present application claims the benefit of the filing date of U.S. Provisional Application No. 63/696,396, filed Sep. 19, 2024, the entire disclosure of which is incorporated by reference herein.

### BACKGROUND

Optical systems signal transmission via fibers are useful in high data rate communications and endoscopic active and passive imaging applications. Typically, bundles of single mode fibers are used for transmission. Using multimode fibers in such optical systems may facilitate high data rate communications and endoscopic active and passive imaging applications. Multimode fibers typically can transmit between 7 and 400 different spatial modes which are available to significantly increase communication data rates or improve spatial resolution of images collected. Bulk optical and spatial light modulator systems have been used to correct for errors in transmission resulting from errors resulting from multimode fiber transmission.

### BRIEF SUMMARY

Aspects of the technology are directed towards a method of adjusting received signals to correct for errors resulting from mode mixing in a multimode fiber. The method comprising receiving, at an optical phased array (OPA) photonic integrated circuit (PIC), a first signal from the multimode fiber; receiving, at the OPA PIC, a plurality of control wavelengths, wherein each of the plurality of control wavelengths is encoded with a distinct spatial mode and wherein the first signal and the plurality of control wavelengths are co-propagating signals; determining, by one or more processors of the OPA PIC, a cross-coupling matrix based on the plurality of control wavelengths, the cross-coupling matrix being indicative of errors in the first signal; and adjusting, by the one or more processors of the OPA PIC, the first signal based on the cross-coupling matrix.

In one example, adjusting, by the one or more processors of the OPA PIC, the first signal based on the cross-coupling matrix includes driving, by the one or more processors of the OPA PIC, a plurality of phase modulators and a plurality of amplitude modulators of the OPA PIC to adjust the first signal based on the cross-coupling matrix.

In another example, adjusting, by the one or more processors of the OPA PIC, the first signal based on the cross-coupling matrix includes computationally correcting, by the one or more processors of the OPA PIC, for the errors in the received first signal based on the cross-coupling matrix.

In a further example, the first signal includes signal information and the signal information includes a number of spatial modes. Additionally or alternatively, a number of control wavelengths may correspond to the number of spatial modes of the first signal.

In an additional example, the errors in the first signal indicated by the cross-coupling matrix include errors resulting from propagation through the multimode fiber.

In a further example, each distinct spatial mode of the plurality of control wavelengths include the same frequency.

In another example, each distinct spatial mode of the plurality of control wavelengths include a different frequency.

In a further example, at least two of the distinct spatial modes of the plurality of control wavelengths include the same frequency and wherein at least two of the distinct spatial modes of the plurality of control wavelengths include a different frequency.

Another aspect of the technology is directed towards a method of transmitting one or more signals via a multimode fiber. The method comprising generating, an optical phased array (OPA) photonic integrated circuit (PIC), a first signal including signal information; adjusting, by one or more processors of the OPA PIC, the first signal based on a cross-coupling matrix, the cross-coupling matrix being determined based on one or more signals received by the OPA PIC via the multimode fiber; and transmitting, by the OPA PIC, the adjusted first signal to the multimode fiber.

In one example, the one or more signals received by the OPA PIC via the multimode fiber includes a signal including signal information and a plurality of control wavelengths. Additional or alternatively, the signal information may include a number of spatial modes. Additionally, a number of received control wavelengths may correspond to the number of spatial modes of the signal including signal information of the one or more signals.

In another example, adjusting, by the one or more processors of the OPA PIC, the first signal based on the cross-coupling matrix includes driving, by the one or more processors of the OPA PIC, a plurality of phase modulators and a plurality of amplitude modulators of the OPA PIC to adjust the first signal based on the cross-coupling matrix.

A further aspect of the technology is directed towards a device. The device comprising an optical phased array (OPA) photonic integrated circuit (PIC) configured to transmit and receive signals, the OPA PIC including one or more processors. The one or more processors configured to determine a cross-coupling matrix based on a plurality of received control wavelengths, the cross-coupling matrix being indicative of errors of signals received from a multimode fiber; adjust signals received from the multimode fiber based on the cross-coupling matrix; and adjust signals to be transmitted from the OPA PIC based on the cross-coupling matrix.

In one example, the errors of received signals indicated by the cross-coupling matrix include errors resulting from propagation through the multimode fiber.

In another example, the device further includes a probe control system configured to generate and receive signals including signal information. Additionally, the probe control system may include a laser source configured to generate signals; a plurality of phase modulators and a plurality of amplitude modulators configured adjust the phase and amplitude of signals passing therethrough; and a plurality of photodiodes operatively coupled to the plurality of phase modulators and the plurality of amplitude modulators, the plurality of photodiodes configured to at least one of phase, amplitude, and polarization of signals.

In an additional example, the device further includes a signal control system configured to generate and receive a plurality of control wavelengths. Additionally, the signal control system may include a laser source configured to generate control wavelengths; a plurality of phase modulators and a plurality of amplitude modulators configured adjust the phase and amplitude of signals passing therethrough; and a plurality of photodiodes operatively coupled to the plurality of phase modulators and the plurality of amplitude modulators, the plurality of photodiodes configured to at least one of phase, amplitude, and polarization of signals.

### BRIEF DESCRIPTION OF DRAWINGS

FIG. 1 is a block diagram of an imaging device in accordance with aspects of the disclosure.

FIG. 2 represents features of an optical phased array architecture in accordance with aspects of the disclosure.

FIG. 3 represents a network in accordance with aspects of the disclosure.

FIGS. 4A-4B illustrate example transmission components of an optical phased array (OPA) photonic integrated circuit (PIC) in accordance with aspects of the disclosure.

FIGS. 5A-5B illustrate example receive components of an optical phased array (OPA) photonic integrated circuit (PIC) in accordance with aspects of the disclosure.

FIG. 6 is a flow diagram in accordance with aspects of the disclosure.

FIG. 7 is a flow diagram in accordance with aspects of the disclosure.

### DETAILED DESCRIPTION

### Overview

The technology relates to systems and methods utilizing an optical phased array (OPA) photonic integrated circuit (PIC) to compensate for mode mixing (e.g., spatial and polarization) and dispersion and in signals (e.g., optical signals which may include encoded data such as encoded image data) transmitted via multimode fibers. Mode mixing may cause errors (e.g., noise, distortion) in signals.

Generally, bundles of single mode fibers are used instead of multimode fibers as mode mixing in such multimode fibers limits the usability thereof. The mode mixing prevents the use of high data rates and increased spatial resolution of imagery in multimode fibers needed for effective operation in certain applications (e.g., high speed internet connectivity, passive imaging, active imaging, imaging processing, endoscopic medical imaging, optical fiber inspection, endoscopic medical imaging, optical fiber inspection, etc.). In some instances, bulk optical and spatial light modulator systems have been used to attempt to compensate for mode mixing in multimode fibers. However, size, cost, and technical performance constraints of such bulk optical and spatial light modulator systems limit implementation into real world systems.

To address this, as noted above, an OPA PIC may be implemented to compensate for mode mixing in multimode fibers. In this regard, the OPA PIC may be used to collect one or more measured values of a plurality of control wavelengths. The one or more measured values may be used to determine a cross-coupling matrix. The cross-coupling matrix may be used to adjust the phase and/or amplitude of a signal to correct for mode mixing. Additionally or alternatively, the OPA PIC may use the cross-coupling matrix to computationally deconvolute (e.g., correct for mode mixing) a signal from a multimode fiber.

The features and methodology described herein may provide systems capable of compensating for mode mixing in signal from multimode fibers. Such systems may allow for use of high data rates and increased spatial resolution of imagery in multimode fibers. As such, multimode fibers may be utilized in certain applications that require these high data rates and increased spatial resolution (e.g., high speed internet connectivity, passive imaging, active imaging, imaging processing, endoscopic medical imaging, optical fiber inspection, etc.) at decreased size, cost, and without technical performance constraints of alternative strategies which limit implementation in real world systems.

### Example Systems

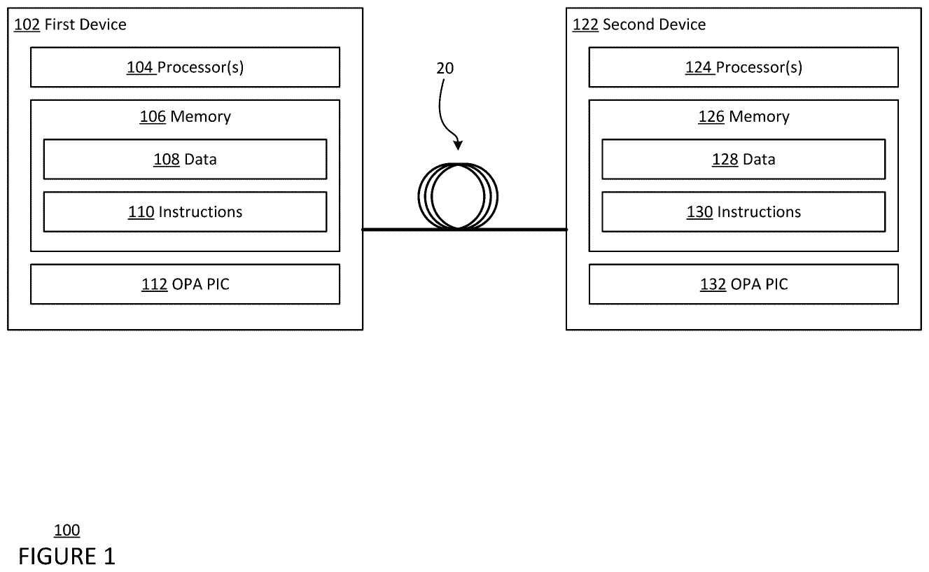

FIG. 1 is a block diagram 100 of a first device 102. The first device 102 may be a first communication terminal configured to transmit signals (e.g., optical signals) and/or form one or more links with a second communications terminal via a multimode fiber, for instance as part of a communication system. The one or more links between the first and second communications terminals may allow for bi-directional transmission of data between the two devices. Additionally or alternatively, the first device 102 may be configured as a first communication terminal configured to transmit signals (e.g., optical signals) and/or form one or more links with a second communications terminal through free-space as part of a free-space optical communication (FSOC) system. In such an instance, the first device 102 may be configured to transmit one or more signals via a multimode fiber and via free space to one or more remote terminals. In one example, as illustrated in FIG. 1, a first device 102 includes one or more processors 104, a memory 106, and an optical phased array (OPA) photonic integrated circuit (PIC) 112. The OPA PIC may include a probe control system, a signal control system, and an optical phased array (OPA), discussed in more detail below. In some implementations, the one or more processors 104 and/or memory may be included on the OPA PIC 112. In some implementations, the first device 102 may include more than one of the above-mentioned components. The addition of more than one of the above-mentioned components may support separate transmit and receive functionality and/or communication with multiple remote devices.

The one or more processors 104 may be any conventional processors, such as commercially available CPUs, GPUs, TPUs, etc. For example, the one or more processors 104 may be one or more complementary metal-oxide semiconductor (CMOS) processors.

Alternatively, the one or more processors 104 may be a dedicated device such as an application specific integrated circuit (ASIC) or another hardware-based processor, such as a field programmable gate array (FPGA). Although FIG. 1 functionally illustrates the one or more processors 104 and memory 106 as being within the same block, the one or more processors 104 and memory 106 may actually comprise multiple processors and memories that may or may not be stored within the same physical housing. Accordingly, references to a processor or computer will be understood to include references to a collection of processors or computers or memories that may or may not operate in parallel.

Memory 106 may store information accessible by the one or more processors 104, including data 108, and instructions 110, that may be executed by the one or more processors 104. The memory may be of any type capable of storing information accessible by the processor, including a computer-readable medium such as a hard-drive, memory card, ROM, RAM, DVD or other optical disks, as well as other write-capable and read-only memories. The system and method may include different combinations of the foregoing, whereby different portions of the data 108 and instructions 110 are stored on different types of media. In the memory of each communications terminal, such as memory 106, calibration information, such as one or more offsets determined for tracking a signal, may be stored.

Data 108 may be retrieved, stored or modified by one or more processors 104 in accordance with the instructions 110. For instance, although the system and method are not limited by any particular data structure, the data 108 may be stored in computer registers, in a relational database as a table having a plurality of different fields and records, XML documents or flat files. The data 108 may also be formatted in any computer-readable format such as, but not limited to, binary values or Unicode. By further way of example only, image data may be stored as bitmaps including of grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data 108 may comprise any information sufficient to identify the relevant information, such as numbers, descriptive text, proprietary codes, references to data stored in other areas of the same memory or different memories (including other network locations) or information that is used by a function to calculate the relevant data.

The instructions 110 may be any set of instructions to be executed directly (such as machine code) or indirectly (such as scripts) by the one or more processors 104. For example, the instructions 110 may be stored as computer code on the computer-readable medium. In that regard, the terms “instructions” and “programs” may be used interchangeably herein. The instructions 110 may be stored in object code format for direct processing by the one or more processors 104, or in any other computer language including scripts or collections of independent source code modules that are interpreted on demand or compiled in advance. Functions, methods and routines of the instructions 110 are explained in more detail below.

The one or more processors 104 may be in communication with the OPA PIC to facilitate transmission and reception of signals. The OPA PIC 112 may include one or more transmitter components and one or more receiver components. The one or more processors 104 may therefore be configured to transmit, via the transmitter components, data in a signal, and also may be configured to receive, via the receiver components, communications and data in a signal. The received signal may be processed by the one or more processors 104 to extract the communications and data.

The transmitter components may include a light source (e.g., light emitting diode (LED), integrated on-PIC laser, external coupled laser, seed laser etc.). Other transmitter components may include an amplifier, such as a high-power semiconductor optical amplifier. In some implementations, the amplifier is on a separate photonics chip. The light output of the light source, or optical signal, may be controlled by a current, or electrical signal, applied directly to the light source, such as from a modulator that modulates a received electrical signal.

The receiver components may include a sensor, such as a photodiode. The sensor may convert a received signal (e.g., light or optical communications beam), into an electrical signal that can be processed by the one or more processors. Other receiver components may include an attenuator, such as a variable optical attenuator, an amplifier, such as a semiconductor optical amplifier, or a filter.

The one or more processors 104 may be in communication with the OPA PIC 112. The OPA PIC 112 may include a micro-lens array, an emitter (e.g., antenna, general coupler, coupling device, etc.) associated with each micro-lens in the array, a plurality of phase shifters, and waveguides that connect the components in the OPA PIC 112. The waveguides progressively merge between a plurality of emitters and an edge coupler that connect to other transmitter and/or receiver components. In this regard, the waveguides may direct signals or light between photodetectors or fiber outside of the OPA PIC 112, the phase shifters the waveguide combiners, the emitters and any additional component within the OPA PIC 112. In particular, the waveguide configuration may combine two waveguides at each stage, which means the number of waveguides is reduced by a factor of two at every successive stage closer to the edge coupler. The point of combination may be a node, and a combiner may be at each node. The combiner may be a 2×2 multimode interference (MMI) or directional coupler.

The OPA PIC 112 may receive light from transmitter components and output the light as a coherent signal to be received by a remote device via free space or a fiber such as multimode fiber 20. In the example illustrated in FIG. 1, the first device 102 may transmit signals to second device 122 via multimode fiber 20. The OPA PIC 112 may also receive signals from free space or a fiber such as multimode fiber 20, from a remote device (e.g., second device 122). The OPA PIC 112 may provide the received signals to the receiver components.

The first device 102 may include additional components to support functions thereof. For example, the first device 102 may include one or more lenses and/or mirrors that form a telescope. The telescope may receive collimated light and output collimated light. The telescope may include an objective portion, an eyepiece portion, and a relay portion. Additionally or alternatively, the first device 102 may include a circulator or wavelength splitter that routes incoming signals (e.g., light) and outgoing signals (e.g., light) while keeping these signals on at least partially separate paths. Additionally or alternatively, the first device may include one or more sensors for detecting measurements of environmental features and/or system components.

Returning to FIG. 1, the second device 122 may be signal configured to transmit and receive signals via free space or a fiber, such as multimode fiber 20, as discussed above with respect to the first device 102. In this regard, the second device 122 includes one or more processors 124, a memory 126, and an OPA PIC 132. The one or more processors 124, memory 126 (including data 128 and instructions 130), and OPA PIC 132 may be configured in the same or similar manner as the one or more processors 104, memory 106, and OPA PIC 112 of the first device 102.

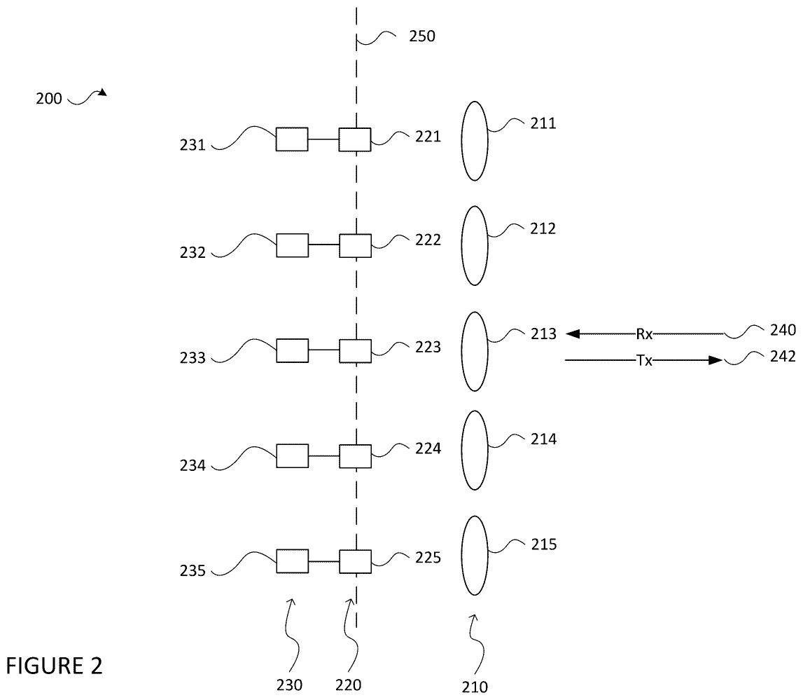

FIG. 2 represents features of an example OPA architecture 200 of an OPA PIC (OPA PIC 112, 132). The OPA architecture 200 includes representations of a micro-lens array 210, a plurality of emitters 220, and a plurality of phase shifters 230. For clarity and ease of understanding, additional waveguides and other features are not depicted. Arrows 240, 242 represent the general direction of transmitted (Tx) signals and received (Rx) signals as such signals pass or travel through the OPA.

The micro-lens array 210 may include a plurality of convex micro-lenses 211-215 that focus the Rx signals onto respective ones of the plurality emitters positioned at the focal points of the micro-lens array. In this regard, the dashed-line 250 represents the focal plane of the micro-lenses 211-215 of the micro-lens array 210. The micro-lens array 210 may be arranged in a grid pattern with a consistent pitch, or distance, between adjacent lenses. In other examples, the micro-lens array 210 may be in different arrangements having different numbers of rows and columns, different shapes, and/or different pitch (consistent or inconsistent) for different lenses.

Each micro-lens of the micro-lens array may be 10's to 100's of micrometers in diameter and height. In addition, each micro-lens of the micro-lens array may be manufactured by molding, printing, or etching a lens directly into a wafer of the OPA architecture 200. Alternatively, the micro-lens array 210 may be molded as a separately fabricated micro-lens array. In this example, the micro-lens array 210 may be a rectangular or square plate of glass or silica a few mm (e.g., 10 mm or more or less) in length and width and 0.2 mm or more or less thick. Integrating the micro-lens array within the OPA architecture 200 may allow for the reduction of the grating emitter size and an increase in the space between emitters. In this way, two-dimensional waveguide routing in the OPA architecture may better fit in a single layer optical phased array. In other instances, rather than a physical micro-lens array, the function of the micro-lens array may be replicated using an array of diffractive optical elements (DOE).

Each micro-lens of the micro-lens array may be associated with a respective emitter of the plurality of emitters 220. For example, each micro-lens may have an emitter from which Tx signals are received and to which the Rx signals are focused. As an example, micro-lens 211 is associated with emitter 221. Similarly, each micro-lens 212-215 also has a respective emitter 222-225. In this regard, for a given pitch (i.e., edge length of a micro-lens edge length) the micro-lens focal length may be optimized for best transmit and receive coupling to the underlying emitters. This arrangement may thus increase the effective fill factor of the Rx signals at the respective emitter, while also expanding the Tx signals received at the micro-lenses from the respective emitter before the Tx signals leave the OPA architecture 200.

The plurality of emitters 220 may be configured to convert emissions from waveguides to free space and vice versa. The emitters may also generate a specific phase and intensity profile to further increase the effective fill factor of the Rx signals and improve the wavefront of the Tx signals. The phase and intensity profile may be determined using inverse design or other techniques in a manner that accounts for how transmitted signals will change as they propagate to and through the micro-lens array. The phase profile may be different from the flat profile of traditional grating emitters, and the intensity profile may be different from the gaussian intensity profile of traditional grating emitters. However, in some implementations, the emitters may be Gaussian field profile grating emitters.

The phase shifters 230 may allow for sensing and measuring Rx signals and the altering of Tx signals to improve signal strength optimally combining an input wavefront into a single waveguide or fiber. Each emitter may be associated with a phase shifter. As shown in FIG. 2, each emitter may be connected to a respective phase shifter. As an example, the emitter 220 is associated with a phase shifter 230. The Rx signals received at the phase shifters 231-235 may be provided to receiver components, and the Tx signals from the phase shifters 231-235 may be provided to the respective emitters of the plurality of emitter 220. The architecture for the plurality of phase shifters 230 may include at least one layer of phase shifters having at least one phase shifter connected to an emitter of the plurality of emitters 220. In some examples, the phase shifter architecture may include a plurality of layers of phase shifters, where phase shifters in a first layer may be connected in series with one or more phase shifters in a second layer.

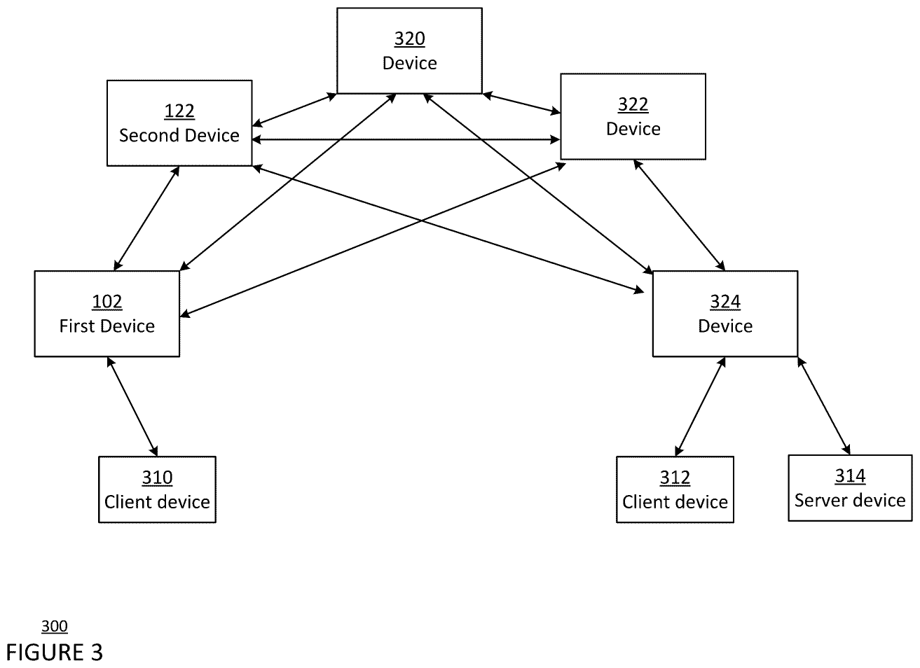

As shown in FIG. 3, a plurality of devices, such as the first device 102 and the second device 122, may be configured to form a plurality of communication links (illustrated as arrows) between a plurality of devices, thereby forming a network 300. The communication links may be formed via optical fibers (e.g., multimode fiber) and/or free space. The network 300 may include client devices 310 and 312, server device 314, and devices 102, 122, 320, 322, and 324. Each of the client devices 310, 312, server device 314, and devices 320, 322, and 324 may include one or more processors, a memory, and an OPA PIC similar to those described above with respect to the first and second devices 102, 122. Using the transmitter and the receiver, each device in network 300 may form at least one communication link with another device, as shown by the arrows. The communication links may be for optical frequencies, radio frequencies, other frequencies, or a combination of different frequency bands. In FIG. 3, the first device 102 is shown having communication links with client device 310 and devices 122, 320, and 322. The second device 122 is shown having communication links with devices 102, 320, 322, and 324. The network 300 as shown in FIG. 3 is illustrative only, and in some implementations the network 300 may include additional or different devices.

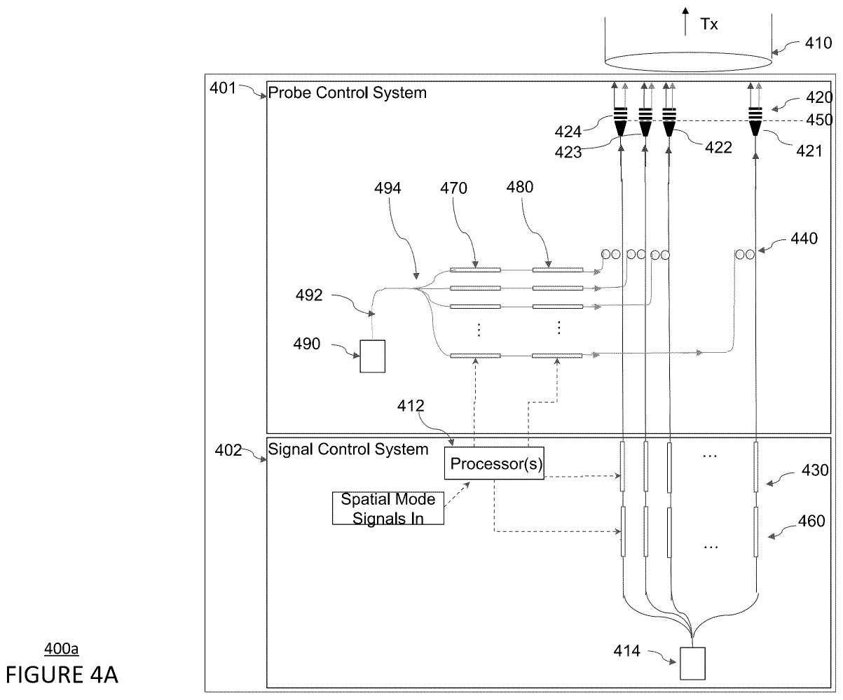

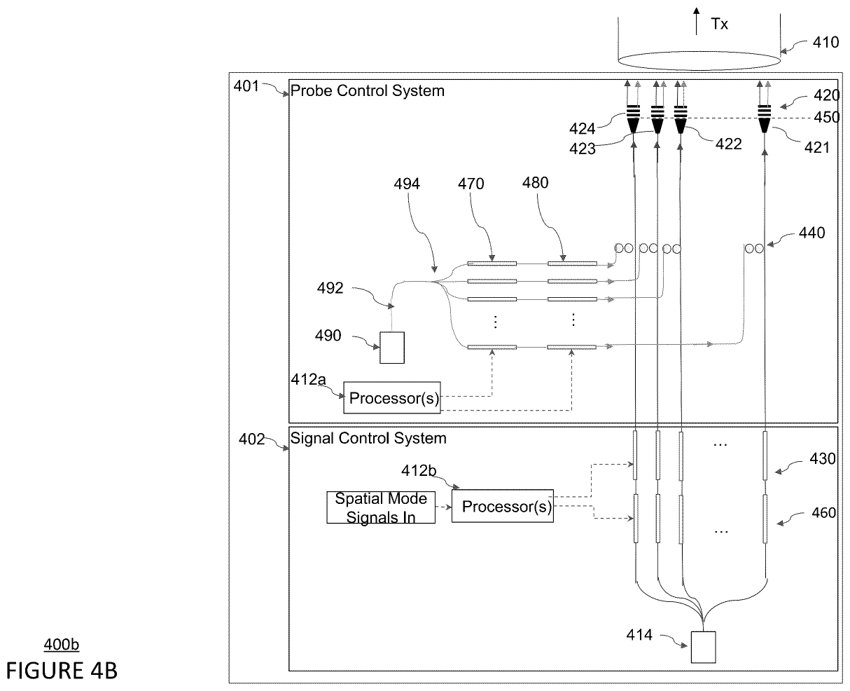

As noted above, systems including an OPA PIC, such OPA PIC 112, 132, may be implemented to compensate for mode mixing. Such mode mixing may occur when signals are transmitted and received via multimode fibers. The OPA PIC may include both transmit and receive functionality. The OPA may be a two dimensional OPA. FIG. 4A illustrates example transmission components of an OPA PIC 400a. The OPA PIC 400a is operatively connected to a multimode fiber 410 and includes a probe control system 401, a signal control system 402, and one or more processors 412. While the one or more processors 412 are shown within the signal control system 402, this is merely for illustrative purposes. The one or more processors 412 and may be disposed of at any location within the OPA PIC 400a. In some instances, the one or more processors 412 may be operatively connected to the OPA PIC 400a and be disposed separately from the OPA PIC 400a. The probe control system 401 includes a laser source 490, waveguide 492, 1×N splitter 494 (where N is an integer number representative of a number of modes discussed further below), a plurality of phase modulators 470, a plurality of amplitude modulators 480, a plurality of wavelength multiplexers or demultiplexers 440, and a plurality of emitters or antennas 420. The signal control system 402 includes a laser source 414, a plurality of phase modulators 430, and a plurality of amplitude modulators 460.

The one or more processors 412 may be any conventional processors, such as commercially available CPUs, GPUs, TPUs, etc. For example, the one or more processors 412 may be one or more complementary metal-oxide semiconductor (CMOS) processors. Alternatively, the one or more processors 412 may be a dedicated device such as an application specific integrated circuit (ASIC) or another hardware-based processor, such as a field programmable gate array (FPGA).

The one or more processors 412 as illustrated are operatively connected to the plurality of phase modulators 470 and the plurality of amplitude modulators 480. In this regard, the one or more processors 412 may be configured to drive (e.g., modify the phase and/or amplitude) of the plurality of phase modulators 470 and the plurality of amplitude modulators 480. The one or more processors 412 may additionally be operatively connected to the laser source 490.

The one or more processors 412 may be configured to induce the probe control system 401 to generate signals (e.g., optical signals). In this regard, the one or more processors 412 may be configured to induce the laser source 490 to generate signals to be propagated via the waveguide 492. The 1×N splitter 494 may be configured to split signals from waveguide 492 such that the signals may be routed into the plurality of phase modulators 470 and the plurality of amplitude modulators 480. The one or more processors 412 may be configured to drive the plurality of phase modulators 470 and the plurality of amplitude modulators 480 to allow for control of one or more characteristics of signals propagated therethrough. The control may include encoding signal information (e.g., images, text, packets, etc.). The signal information may include a plurality of modes (e.g., spatial modes). As an example, a signal including signal information, Sᵢ encoded with N modes may represented as follows:

$${S}_{i} = {A}_{i} Mode 1 + {B}_{i} Mode 2 + {C}_{i} Mode 3 + … {N}_{i} ModeN$$

In this example, each of Aᵢ, Bᵢ, Cᵢ . . . . Nᵢ may be general complex numbers.

The one or more processors 412 as illustrated are also operatively connected to the plurality of phase modulators 430 and the plurality of amplitude modulators 460. In this regard, the one or more processors 412 may be configured to drive (e.g., modify the phase and/or amplitude) of the plurality of phase modulators 430 and the plurality of amplitude modulators 460. The one or more processors 412 may additionally be operatively connected to the laser source 414.

The one or more processors 412 may be configured to drive the signal control system 402 generate a plurality of control wavelengths. Each of the plurality of control wavelengths may include a distinct spatial mode. Each spatial mode may correspond to a basis set of spatial modes (e.g., orthogonal Laguerre-Gaussian basis set or other orthonormal basis set). The one or more control wavelengths may assist with mode mixing correction and also may be used as a reference to correct static and dynamic phase errors. In this regard, the one or more processors 412 may be configured to induce the laser source 414 (e.g., light emitting diode (LED), integrated on-PIC laser, external coupled laser, etc.) to generate the plurality of control wavelengths. The plurality of phase modulators 430 and the plurality of amplitude modulators 460 may encode the distinct spatial modes onto the plurality of control wavelengths. In some instances, the number of control wavelengths and/or corresponding spatial modes may correspond to the number of modes encoded as signal information discussed above.

Each spatial mode may be encoded via a time-division methodology, a frequency-division methodology, or a hybrid time-frequency division methodology. For the time-division methodology, each spatial mode may be applied sequentially. By way of example, one to N spatial modes may be applied at differing timesteps. In this regard, a first spatial mode may be applied at a first timestep, a second spatial mode may be applied at a second timestep, and the Nth spatial mode may be applied at an Nth timestep. In some instances, the timesteps may be in the order of 1 microsecond or more or less. A frequency for each applied spatial mode may be selected from a predetermined set of frequencies. The frequency of each applied spatial mode may be the same or may be different from one another.

For the frequency-division methodology, each spatial mode may be applied simultaneously. By way of example, one to N spatial modes may be applied during the same timestep such that each spatial mode does not interfere. In this regard, a first spatial mode may be applied at a first frequency, a second spatial mode may be applied at a second frequency, and the Nth spatial mode may be applied at an Nth frequency. Each spatial mode frequency may be selected from a predetermined set of frequencies. The spatial mode frequencies may be in a range of, for example, 100 KHz to 10 MHz or more or less. In some instances, each of the frequencies of the predetermined set of frequencies may be unique. In such instances, the frequencies of the predetermined set of frequencies may be selected such that the frequencies do not interfere with one another.

For the hybrid time-frequency division methodology multiple spatial modes may be applied at each timestep. By way of example, one to N spatial modes may be applied. In this regard, a first spatial mode and a second spatial mode may be applied at a first timestep, where the first spatial mode may be applied at a first frequency and the second spatial mode may be applied at a second frequency. Additionally, an N−1 spatial mode and a Nth spatial mode may be applied at an Nth timestep, where the N−1 spatial mode may be applied at an N−1 frequency and the Nth spatial mode may be applied at an Nth frequency. Each spatial mode frequency may be selected from a predetermined set of frequencies. In some instances, each of the frequencies of the predetermined set of frequencies may be unique. In such instances, the frequencies of the predetermined set of frequencies may be selected such that the frequencies do not interfere with one another. In some instances, each frequency used to apply a spatial mode may be a different frequency from the set of frequencies. Alternatively, the frequencies used in each different timesteps may be the same. For example, the first frequency may be the same as the N−1 frequency and the second frequency may be the same as the Nth frequency.

The plurality of multiplexers or demultiplexers 440 may be configured to receive signals from the plurality of phase modulators 470 and the plurality of amplitude modulators 480 and the plurality of control wavelengths from the signal control system 402. The plurality of multiplexers or demultiplexers 440 are further configured to direct such signals and the plurality of control wavelengths to the plurality of emitters 420 such that such signals and the plurality of control wavelengths are co-propagating signals.

The plurality of emitters 420 may be formed as an array and be configured to transmit the co-propagating signals (e.g., signals including signal information and the plurality of control wavelengths) through free-space to the multimode fiber 410. The plurality of emitters may be arranged along an emitter image plane. In this regard, FIG. 4A illustrates the plurality of emitters 420, including emitters 421-424, along emitter image plane 450. The emitters may also generate a specific phase and intensity profile to improve the wavefront of transmitted signals. The phase and intensity profile may be determined using inverse design or other techniques in a manner that accounts for how transmitted light will change as it propagates to and through the multimode fiber 410.

In some implementations, the plurality of emitters 420 may be single polarization emitters. In such an implementation, the single polarization emitters may be arranged in a cartesian configuration and each emitter 421-424 may be two single polarization emitters. Single polarization emitters may allow for increased performance and tuning capabilities. Alternatively, the plurality of emitters 420 may be dual polarization emitters. In such an implementation, the dual polarization emitters may be arranged in a radial configuration and each emitter 421-424 may be one dual polarization emitter. Dual polarization emitters may allow for lower cost and simpler array design.

FIG. 4B illustrates another example of an OPA PIC 400b including transmission components. The OPA PIC 400b illustrates an example where the probe control system 401 and the signal control system 402 each include dedicated one or more processors. In this regard, the probe control system 401 of OPA PIC 400b includes one or more probe control system processors 412a. Similarly, the signal control system 402 of OPA PIC 400b includes one or more signal control system processors 412b.

Like the one or more processors 412, the one or more probe control system processors 412a and the one or more signal control system processors 412b may be any conventional processors, such as commercially available CPUs, GPUs, TPUs, etc. For example, the one or more probe control system processors 412a and the one or more signal control system processors 412b may be one or more complementary metal-oxide semiconductor (CMOS) processors. Alternatively, the one or more probe control system processors 412a and the one or more signal control system processors 412b may be a dedicated device such as an application specific integrated circuit (ASIC) or another hardware-based processor, such as a field programmable gate array (FPGA).

The one or more probe control system processors 412a as illustrated are operatively connected to the plurality of phase modulators 470 and the plurality of amplitude modulators 480. In this regard, the one or more probe control system processors 412a may be configured to drive (e.g., modify the phase and/or amplitude) of the plurality of phase modulators 470 and the plurality of amplitude modulators 480. The one or more probe control system processors 412a may additionally be operatively connected to the laser source 490.

The one or more probe control system processors 412a may be configured to induce the probe control system 401 to generate signals (e.g., optical signals). In this regard, the one or more processors 412 may be configured to induce the laser source 490 to generate signals to be propagated via the waveguide 492. The 1×N splitter 494 may be configured to split signals from waveguide 492 such that the signals may be routed into the plurality of phase modulators 470 and the plurality of amplitude modulators 480. The one or more probe control system processors 412a may be configured to drive the plurality of phase modulators 470 and the plurality of amplitude modulators 480 to allow for control of one or more characteristics of signals propagated therethrough. The control may include encoding signal information (e.g., images, text, packets, etc.). As noted above, a signal including signal information, such as signal Sᵢ, may include a plurality of modes (e.g., spatial modes).

The one or more signal control system processors 412b as illustrated are operatively connected to the plurality of phase modulators 430 and the plurality of amplitude modulators 460. In this regard, the one or more signal control system processors 412b may be configured to drive (e.g., modify the phase and/or amplitude) of the plurality of phase modulators 430 and the plurality of amplitude modulators 460. The one or more signal control system processors 412b may additionally be operatively connected to the laser source 414.

The one or more signal control system processors 412b may be configured to drive the signal control system 402 generate a plurality of control wavelengths. Each of the plurality of control wavelengths may include a distinct spatial mode. Each spatial mode may correspond to a basis set of spatial modes (e.g., orthogonal Laguerre-Gaussian basis set or other orthonormal basis set). The one or more control wavelengths may assist with mode mixing correction may be used as a reference to correct static and dynamic phase errors. In this regard, the one or more signal control system processors 412b may be configured to induce the laser source 414 (e.g., light emitting diode (LED), integrated on-PIC laser, external coupled laser, etc.) to generate the plurality of control wavelengths. The plurality of phase modulators 430 and the plurality of amplitude modulators 460 may encode the distinct spatial modes onto the plurality of control wavelengths. In some instances, the number of control wavelengths and/or corresponding spatial modes may correspond to the number of modes encoded as signal information discussed above. In this regard, each spatial mode may be encoded via a time-division methodology, a frequency-division methodology, or a hybrid time-frequency division methodology

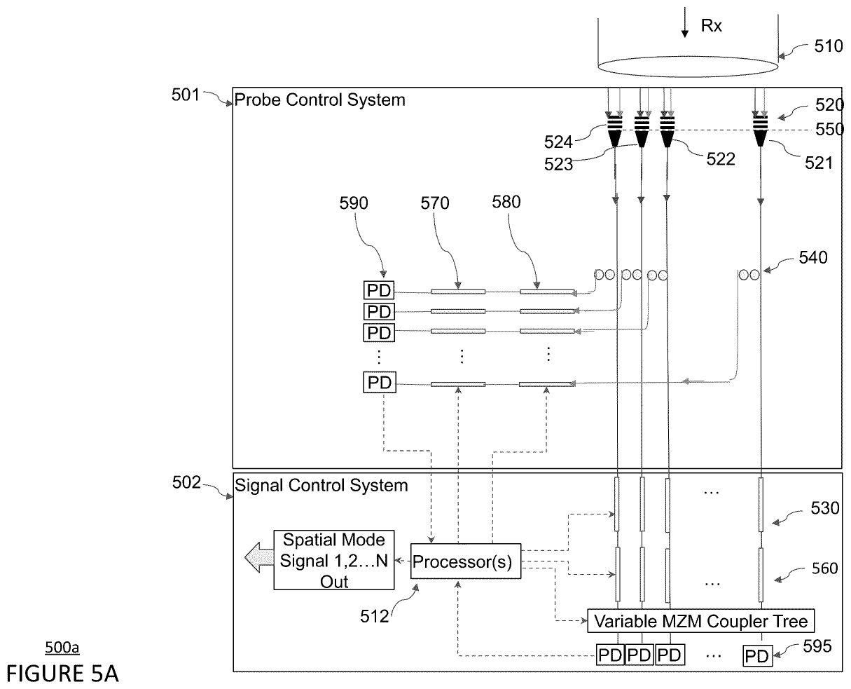

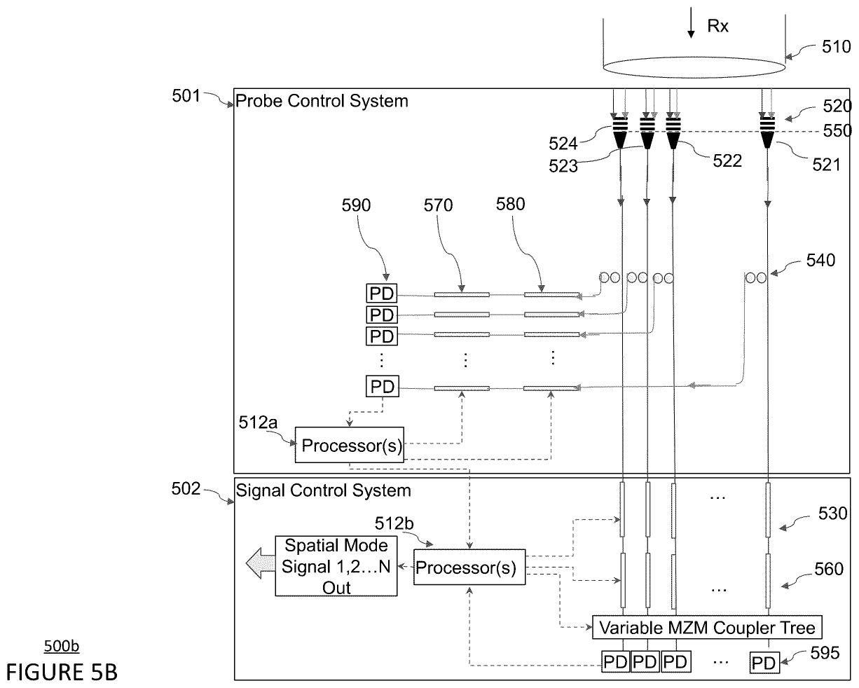

FIG. 5A illustrates example receive components of an OPA PIC 500a. The OPA PIC 500a is operatively connected to a multimode fiber 510 and includes a probe control system 501, a signal control system 502, and one or more processors 512. While the one or more processors 512 are shown within the signal control system 502, this is merely for illustrative purposes. The one or more processors 512 and may be disposed of at any location within the OPA PIC 500a. In some instances, the one or more processors 512 may be operatively connected to the OPA PIC 500a and be disposed separately from the OPA PIC 500a. The probe control system 501 includes a plurality of photodiodes 590, a plurality of phase modulators 570, a plurality of amplitude modulators 580, a plurality of wavelength multiplexers or demultiplexers 540, and a plurality of emitters or antennas 520. The signal control system 502 includes a plurality of photodiodes 595, a plurality of phase modulators 530, a plurality of amplitude modulators 560, and a phase modulator tree.

The plurality of emitters 520 may be formed as an array and be configured to receive signals from the multimode fiber 510 through free-space. The signals may be the co-propagating signals discussed above (e.g., signals including signal information and the plurality of control wavelengths). The plurality of emitters may be arranged along an emitter image plane. In this regard, FIG. 5A illustrates the plurality of emitters 520, including emitters 521-524, along emitter image plane 550. The emitters may also generate a specific phase and intensity profile to increase the effective fill factor of received signals. In some implementations, the plurality of emitters 520 may be single polarization emitters. In such an implementation, the single polarization emitters may be arranged in a cartesian configuration and each emitter 521-524 may be two single polarization emitters. Alternatively, the plurality of emitters 520 may be dual polarization emitters. In such an implementation, the dual polarization emitters may be arranged in a radial configuration and each emitter 521-524 may be one dual polarization emitter.

The plurality of multiplexers or demultiplexers 540 may be configured to direct signals received at the plurality of emitters 520 to one or more components configured to assist with reception (e.g., coherent reception). In this regard, the plurality of multiplexers may be configured to direct signals, including signal information, towards the components of the probe control system 501 (e.g., the plurality of photodiodes 590, the plurality of phase modulators 570, and the plurality of amplitude modulators 580) and the one or more control wavelengths towards the signal control system 502. In this regard, the signals including signal information may be received by the probe control system and the plurality of control wavelengths may be received by the signal control system.

The plurality of photodiodes 590 as illustrated are coupled to the plurality of phase modulators 570 and the plurality of amplitude modulators 580. In some instances, the plurality of phase modulators 570 and plurality of amplitude modulators 580 may each be formed as one or more layers or one or more arrays. In such an instance, one or more photodiodes of the plurality of photodiodes 590 may be coupled to each phase modulator and each amplitude modulator in the one or more layers. In some instances, a single photodiode may be coupled to two or more phase and amplitude modulators of a layer via a waveguide tap coupler. The plurality of photodiodes may be configured to measure one or more values. The one or more measured values may include phase, amplitude, polarization, etc.

The plurality of photodiodes 595 as illustrated are coupled to the plurality of phase modulators 530, the plurality of amplitude modulators 560, and the phase modulator tree. The phase modulator tree may include a plurality of layers with varying numbers of phase modulators in each layer. In some instances, the plurality of phase modulators 530 and plurality of amplitude modulators 560 may each be formed as one or more layers or one or more arrays. In such an instance, one or more photodiodes of the plurality of photodiodes 595 may be coupled to each phase modulator and each amplitude modulator in the one or more layers. Similarly, one or more photodiodes of the plurality of photodiodes 595 may be coupled to each phase modulator of the phase modulator tree. In some instances, a single photodiode may be coupled to two or more phase and amplitude modulators via a waveguide tap coupler. The plurality of photodiodes may be configured to measure one or more values. The one or more measured values may include phase, amplitude, polarization, etc. In some instances, the plurality of phase modulators 530 may be included in the phase modulator tree or vice versa.

The one or more processors 512 as illustrated are operatively connected to the plurality of phase modulators 570, the plurality of amplitude modulators 580, and the plurality of photodiodes 590. The one or more processors 512 as illustrated are further operationally connected to the plurality of phase modulators 530, the plurality of amplitude modulators 560, the phase modulator tree, and the plurality of photodiodes 595.

The one or more processors 512 may be any conventional processors, such as commercially available CPUs, GPUs, TPUs, etc. For example, the one or more processors 512 may be one or more complementary metal-oxide semiconductor (CMOS) processors. Alternatively, the one or more processors 512 may be a dedicated device such as an application specific integrated circuit (ASIC) or another hardware-based processor, such as a field programmable gate array (FPGA).

The one or more processors 512 may be configured to drive (e.g., modify the phase and/or amplitude) of the plurality of phase modulators 570 and the plurality of amplitude modulators 580 to facilitate coherent reception of optical signals. Additionally, the one or more processors 512 may be configured to drive the plurality of phase modulators 530, the plurality of amplitude modulators 560, and the phase modulator tree to facilitate coherent reception of optical signals.

The one or more processors 512 may be further configured to receive one or more measured values from the plurality of photodiodes 590. Additionally, the one or more processors 512 may be configured to receive one or more measured values from the plurality of photodiodes 595. The one or more processors 512 may utilize the one or more values measured by the plurality of photodiodes 590 to drive the plurality of phase modulators 570 and the plurality of amplitude modulators 580. In some instances, the one or more measured values may be used to compensate for phase errors resulting from mode mixing. Similarly, the one or more processors 512 may be configured to may utilize the one or more values measured by the plurality of photodiodes 595 to drive the plurality of phase modulators 530, the plurality of amplitude modulators 560, and the phase modulator tree to assist in coherent reception.

In some instances, the one or more measured values may be used to compensate or correct for phase errors (e.g., noise, distortion) resulting from mode mixing. In this regard, the one or more processors 512 may use the one or more measured values from the plurality of photodiodes to detect received control wavelengths of the plurality of control wavelengths discussed above. In some instances, the one or more processors 512 may use received control wavelengths and the measured values thereof to determine a cross-coupling matrix. The measured values and corresponding cross-coupling matrix may be indicative of changes to the phase and amplitude of the one or more control wavelengths following their propagation via the multimode fiber. The changes may be indicative of errors resulting from mode mixing. As such, the cross-coupling matrix may further be indicative of errors in the first signal resulting from propagation through the multimode fiber.

The one or more processors 512 may use the cross-coupling matrix to calculate a vector phase conjugate. The one or more processors 512 may apply the vector phase conjugate to received signals including signal information. In some instances, the vector phase conjugate is applied computationally by the one or more processors 512. Additionally or alternatively, the vector phase conjugate may be applied via the plurality of phase modulators 570 and the plurality of amplitude modulators 580 during reception of the signals. In this regard, the one or more processors 512 may be configured to drive the plurality of phase modulators 570 and the plurality of amplitude modulators 580 to apply the vector phase conjugate. The vector phase conjugate may reflect adjustments to the received signals including signal information to correct for errors resulting from mode mixing.

In some instances, the adjustment of the received signals may be conducted in a similar manner discussed above with respect to the time-division methodology, the frequency-division methodology, or the hybrid time-frequency division methodology. In this regard, the one or more processors 512 may determine a cross-coupling matrix, calculate a vector phase conjugate, and apply the vector phase conjugate to the received signals including signal information as the plurality of control wavelengths and their encoded spatial modes are received. Based on the transmission according to the time-division methodology, the frequency-division methodology, or the hybrid time-frequency division methodology, the plurality of control wavelengths may be received simultaneously, iteratively, or by some combination thereof.

In some instances, the determined cross-coupling matrix and corresponding vector conjugate may be used as a set point in the transmission of optical signals including signal information. For example, after determining the cross-coupling matrix and corresponding vector conjugate the system may apply the vector conjugate to beams to be transmitted by the OPA PIC.

FIG. 5B illustrates another example of an OPA PIC 500b including receive components. The OPA PIC 500b illustrates an example where the probe control system 501 and the signal control system 502 each include dedicated one or more processors. In this regard, the probe control system 501 of OPA PIC 500b includes one or more probe control system processors 512a. Similarly, the signal control system 502 of OPA PIC 500b includes one or more signal control system processors 512b.

The one or more probe control system processors 512a as illustrated are operatively connected to the plurality of phase modulators 570, the plurality of amplitude modulators 580, the plurality of photodiodes 590, and the one or more signal control system processors 512b. The one or more signal control system processors 512b as illustrated are further operationally connected to the plurality of phase modulators 530, the plurality of amplitude modulators 560, the phase modulator tree, and the plurality of photodiodes 595.

The one or more probe control system processors 512a and the one or more signal control system processors 512b may be any conventional processors, such as commercially available CPUs, GPUs, TPUs, etc. For example, the one or more probe control system processors 512a and the one or more signal control system processors 512b may be one or more complementary metal-oxide semiconductor (CMOS) processors. Alternatively, the one or more probe control system processors 512a and the one or more signal control system processors 512b may be a dedicated device such as an application specific integrated circuit (ASIC) or another hardware-based processor, such as a field programmable gate array (FPGA).

The one or more probe control system processors 512a may be configured to drive (e.g., modify the phase and/or amplitude) of the plurality of phase modulators 570 and the plurality of amplitude modulators 580 to facilitate coherent reception of optical signals. Similarly, the one or more signal control system processors 512b may be configured to drive the plurality of phase modulators 530, the plurality of amplitude modulators 560, and the phase modulator tree to facilitate coherent reception of optical signals.

Additionally, the one or more probe control system processors 512a may be further configured to receive one or more measured values from the plurality of photodiodes 590. Similarly, the one or more signal control system processors 512b may be configured to receive one or more measured values from the plurality of photodiodes 595. The one or more probe control system processors 512a may utilize the one or more values measured by the plurality of photodiodes 590 to drive the plurality of phase modulators 570 and the plurality of amplitude modulators 580. In some instances, the one or more measured values may be used to compensate for phase errors resulting from mode mixing. Similarly, the one or more signal control system processors 512b may be configured to may utilize the one or more values measured by the plurality of photodiodes 595 to drive the plurality of phase modulators 530, the plurality of amplitude modulators 560, and the phase modulator tree to assist in coherent reception.

In some instances, the one or more measured values may be used to compensate or correct for phase errors (e.g., noise, distortion) resulting from mode mixing. In this regard, the one or more signal control system processors 512b may use the one or more measured values from the plurality of photodiodes to detect received control wavelengths of the plurality of control wavelengths discussed above. In some instances, the one or more signal control system processors 512b may use received control wavelengths and the measured values thereof to determine a cross-coupling matrix. The measured values and corresponding cross-coupling matrix may be indicative of changes to the phase and amplitude of the one or more control wavelengths following their propagation via the multimode fiber. The changes may be indicative of errors resulting from mode mixing. As such, the cross-coupling matrix may further be indicative of errors in the first signal resulting from propagation through the multimode fiber.

The one or more signal control system processors 512b may use the cross-coupling matrix to calculate a vector phase conjugate. The one or more signal control system processors 512b may apply the vector phase conjugate to received signals including signal information. In some instances, the vector phase conjugate is applied computationally by the one or more signal control system processors 512b. Additionally or alternatively, the vector phase conjugate may be applied via the plurality of phase modulators 570 and the plurality of amplitude modulators 580 during reception of the signals. In this regard, the one or more probe control system processors 512a may be configured to drive the plurality of phase modulators 570 and the plurality of amplitude modulators 580 to apply the vector phase conjugate. The vector phase conjugate may reflect adjustments to the received signals including signal information to correct for errors resulting from mode mixing.

In some instances, the adjustment of the received signals may be conducted in a similar manner discussed above with respect to the time-division methodology, the frequency-division methodology, or the hybrid time-frequency division methodology. In this regard, the one or more probe control system processors 512a and/or the one or more signal control system processors 512b may determine a cross-coupling matrix, calculate a vector phase conjugate, and apply the vector phase conjugate to the received signals including signal information as the plurality of control wavelengths and their encoded spatial modes are received. Based on the transmission according to the time-division methodology, the frequency-division methodology, or the hybrid time-frequency division methodology, the plurality of control wavelengths may be received simultaneously, iteratively, or by some combination thereof.

In some instances, the determined cross-coupling matrix and corresponding vector conjugate may be used as a set point in the transmission of optical signals including signal information (e.g., Si). For example, after determining the cross-coupling matrix and corresponding vector conjugate the system may apply the vector conjugate to beams to be transmitted by the OPA PIC.

While FIGS. 4A-5B illustrate the transmit and receive components separately, a signal OPA PIC may be configured with both transmit and receive components as discussed above. In this regard, a device may be configured to perform bi-directional communication via an included OPA PIC. In other instances, a device may include OPA PICs with separate transmit and receive components.

### Example Methods

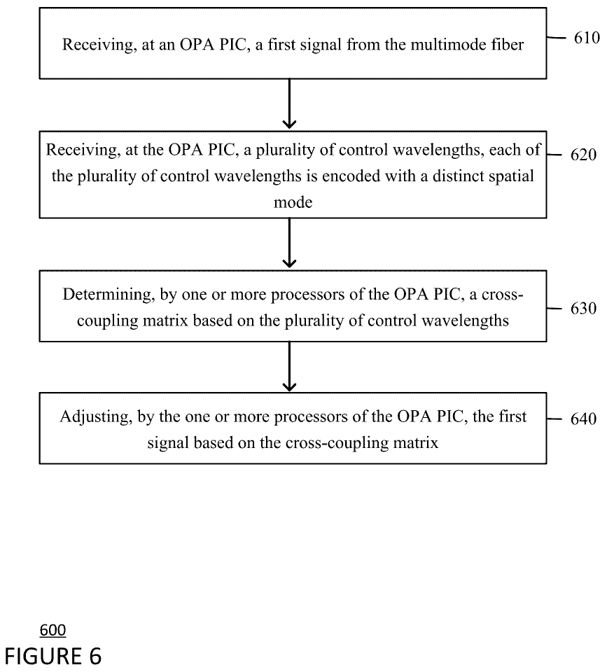

The OPA PIC, discussed above, may be used in a method of adjusting received signals to correct for errors resulting from mode mixing in a multimode fiber. The mode mixing may occur as a result of propagation of a signal from one device to another (e.g., the first device and the second device) through a multimode fiber. FIG. 6 illustrates an example method 600 of adjusting received signals to correct for errors resulting from mode mixing in a multimode fiber. At block 610, the method includes receiving, at an OPA PIC, a first signal from the multimode fiber. The first signal may include signal information. In this regard, a plurality of emitters 220, 520 of the OPA PIC 112, 132, 500a, 500b may receive signals through free space from a multimode fiber 20, 410, 510. The signals, such as for example signal Si, may include signal information as discussed above. The signals including signal information may be routed to a probe control system 501 of the OPA PIC 112, 132, 500a, 500b via a plurality of multiplexers 540. In some instances, the first signal may be a signal transmitted from a remote device (e.g., the second device 122) and received at the first device 102 or vice versa. The transmission of the first signal may be conducted using transmission components of an OPA PIC 112, 132, 400a, 400b as discussed above.

At block 620, the method further includes receiving, at the OPA PIC, a plurality of control wavelengths, each of the plurality of control wavelengths is encoded with a distinct spatial mode. The first signal and the plurality of control wavelengths may be co-propagating signals. In this regard, the plurality of emitters 220, 520 of the OPA PIC 112, 132, 500a, 500b may receive the plurality of control wavelengths that are co-propagating with the first signal. The plurality of control wavelengths may each be encoded with a distinct spatial mode as discussed above. The plurality of multiplexers 540 may route the plurality of control wavelengths to the signal control system of the OPA PIC 112, 132, 500a, 500b. In some instances, the plurality of control wavelengths may be a plurality of control wavelengths transmitted from a remote device (e.g., the second device 122) and received at the first device 102 or vice versa. The transmission of the plurality of control wavelengths may be conducted using transmission components of an OPA PIC 112, 132, 400a, 400b as discussed above.

At block 630, the method further includes determining, by one or more processors of the OPA PIC, a cross-coupling matrix based on the plurality of control wavelengths. The cross-coupling matrix being indicative of errors in the first signal. In this regard, the one or more processors 512 or one or more signal control system processors 512b may use the one or more measured values from a plurality of photodiodes to detect received control wavelengths of the plurality of control wavelengths discussed above. The one or more processors 512 or one or more signal control system processors 512b may use received control wavelengths and the one or more measured values thereof to determine a cross-coupling matrix. The measured one or more values and corresponding cross-coupling matrix may be indicative of changes to the phase and amplitude of the one or more control wavelengths following their propagation via the multimode fiber 20, 410, 510. The changes may be indicative of errors resulting from mode mixing. As such, the cross-coupling matrix may further be indicative of errors in the first signal resulting from propagation through the multimode fiber. In some instances, the one or more processors 512 or one or more signal control system processors 512b may use the cross-coupling matrix to calculate a vector phase conjugate.

At block 640, the method further includes adjusting, by the one or more processors of the OPA PIC, the first signal based on the cross-coupling matrix. In this regard, the one or more processors 512, one or more signal control system processors 512b, or one or more probe control system processors 512a of the OPA PIC 112, 132, 500a, 500b may apply the calculated vector phase conjugate to received signals including signal information. In some instances, the vector phase conjugate is applied computationally by the one or more processors 512 or the one or more signal control system processors 512b. Additionally or alternatively, the vector phase conjugate may be applied via the plurality of phase modulators 570 and the plurality of amplitude modulators 580 of the probe control system 501 during reception of the signals. In this regard, the one or more processors 512 or the one or more probe control system processors 512a of the OPA PIC 112, 132, 500a, 500b may be configured to drive the plurality of phase modulators 570 and the plurality of amplitude modulators 580 to apply the vector phase conjugate. The vector phase conjugate may reflect adjustments to the received signals including signal information to correct for errors resulting from mode mixing.

In some instances, the adjustment of the received signals may be conducted in a similar manner discussed above with respect to the time-division methodology, the frequency-division methodology, or the hybrid time-frequency division methodology. In this regard, the one or more processors 512, the one or more signal control system processors 512b, and/or the one or more probe control system processors 512a may determine a cross-coupling matrix, calculate a vector phase conjugate, and apply the vector phase conjugate to the received signals including signal information as the plurality of control wavelengths and their encoded spatial modes are received. Based on the transmission according to the time-division methodology, the frequency-division methodology, or the hybrid time-frequency division methodology, the plurality of control wavelengths may be received simultaneously, iteratively, or by some combination thereof.

In some instances, the determined cross-coupling matrix and corresponding vector conjugate may be used as a set point in the transmission of optical signals including signal information. For example, after determining the cross-coupling matrix and corresponding vector conjugate the system may apply the vector conjugate to beams to be transmitted by the OPA PIC.

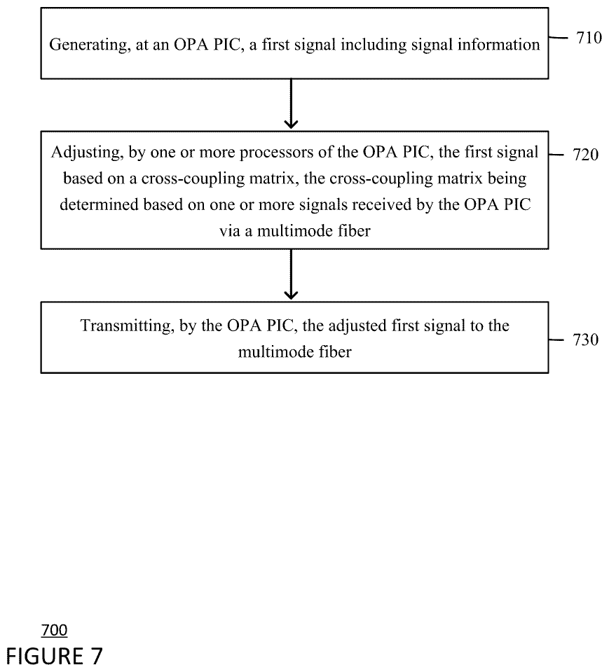

In this regard, the OPA PIC may be used in a method of transmitting signals via a multimode fiber. FIG. 7 illustrates an example method 700 of transmitting one or more signals via a multimode fiber. At block 710, the method includes generating, at an OPA PIC, a first signal, such as the signal Si, including signal information. In this regard, the one or more processors 412 or one or more probe control system processors 412a of the OPA PIC 112, 132, 400a, 400b may be configured to induce the laser source 490 to generate signals (e.g., optical signals) to be propagated via the waveguide 492. The 1×N splitter 494 may be configured to split signals from waveguide 492 such that the signals may be routed into the plurality of phase modulators 470 and the plurality of amplitude modulators 480. The one or more processors 412 or one or more probe control system processors 412a may be configured to drive the plurality of phase modulators 470 and the plurality of amplitude modulators 480 to allow for control of one or more characteristics of signals propagated therethrough. The control may include encoding signal information (e.g., images, text, packets, etc.) including a plurality of modes as discussed above.

At block 720 the method includes adjusting, by one or more processors of the OPA PIC, the first signal based on a cross-coupling matrix, the cross-coupling matrix being determined based on one or more signals received by the OPA PIC via a multimode fiber. In this regard, the one or more processors 412 or one or more probe control system processors 412a of the OPA PIC 112, 132, 400a, 400b may apply the calculated vector phase conjugate to transmitted signals including signal information. In some instances, the vector phase conjugate is applied computationally by the one or more processors 412 or the one or more signal control system processors 412b prior to signal generation. Additionally or alternatively, the vector phase conjugate may be applied via the plurality of phase modulators 470 and the plurality of amplitude modulators 480 of the probe control system 401 during transmission of the signals. In this regard, the one or more processors 412 or the one or more probe control system processors 412a of the OPA PIC 112, 132, 400a, 400b may be configured to drive the plurality of phase modulators 470 and the plurality of amplitude modulators 480 to apply the vector phase conjugate. The vector phase conjugate may reflect adjustments to the transmitted signals including signal information to correct for errors resulting from mode mixing. The errors may be errors corresponding to a previously received signal.

The one or more signals on which the cross-coupling matrix is based may include a signal and a plurality of control wavelengths previously received at the OPA PIC 112, 132, 500a, 500b of the first device 102. The cross-coupling matrix may be determined in the manner discussed above with respect to method 600. In such an example, the signal may be the first signal of method 600 and the plurality of control wavelengths may be the plurality of control wavelengths of method 600.

At block 730, the method includes transmitting, by the OPA PIC, the adjusted first signal to the multimode fiber. In this regard, the plurality of emitters 220, 420 of the OPA PIC 112, 132, 400a, 400b may transmit signals through free space to the multimode fiber 20, 410, 510. The signals may include signal information as discussed above. In some instances, the OPA PIC 112, 132, 400a, 400b may additionally generate and transmit a plurality of control wavelengths as discussed above. The plurality of control wavelengths may co-propagate with the first signal.

The features and methodology described herein may provide systems capable of compensating for mode mixing in signal from multimode fibers. Such systems may allow for use of high data rates and increased spatial resolution of imagery in multimode fibers. As such, multimode fibers may be utilized in certain applications that require these high data rates and increased spatial resolution (e.g., high speed internet connectivity, passive imaging, active imaging, imaging processing, etc.) at decreased size, cost, and without technical performance constraints of alternative strategies which limit implementation in real world systems.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method of adjusting received signals to correct for errors resulting from mode mixing in a multimode fiber, the method comprising:
receiving, at an optical phased array (OPA) photonic integrated circuit (PIC), a first signal from the multimode fiber;
receiving, at the OPA PIC, a plurality of control wavelengths, wherein each of the plurality of control wavelengths is encoded with a distinct spatial mode and wherein the first signal and the plurality of control wavelengths are co-propagating signals;
determining, by one or more processors of the OPA PIC, a cross-coupling matrix based on the plurality of control wavelengths, the cross-coupling matrix being indicative of errors in the first signal; and
adjusting, by the one or more processors of the OPA PIC, the first signal based on the cross-coupling matrix.

2. The method of claim 1, wherein adjusting, by the one or more processors of the OPA PIC, the first signal based on the cross-coupling matrix includes driving, by the one or more processors of the OPA PIC, a plurality of phase modulators and a plurality of amplitude modulators of the OPA PIC to adjust the first signal based on the cross-coupling matrix.

3. The method of claim 1, wherein adjusting, by the one or more processors of the OPA PIC, the first signal based on the cross-coupling matrix includes computationally correcting, by the one or more processors of the OPA PIC, for the errors in the received first signal based on the cross-coupling matrix.

4. The method of claim 1, wherein the first signal includes signal information, the signal information including a number of spatial modes.

5. The method of claim 4, wherein a number of control wavelengths corresponds to the number of spatial modes of the first signal.

6. The method of claim 1, wherein the errors in the first signal indicated by the cross-coupling matrix include errors resulting from propagation through the multimode fiber.

7. The method of claim 1, wherein each distinct spatial mode of the plurality of control wavelengths include the same frequency.

8. The method of claim 1, wherein each distinct spatial mode of the plurality of control wavelengths include a different frequency.

9. The method of claim 1, wherein at least two of the distinct spatial modes of the plurality of control wavelengths include the same frequency and wherein at least two of the distinct spatial modes of the plurality of control wavelengths include a different frequency.

10. A method of transmitting one or more signals via a multimode fiber, the method comprising:
generating, an optical phased array (OPA) photonic integrated circuit (PIC), a first signal including signal information;
adjusting, by one or more processors of the OPA PIC, the first signal based on a cross-coupling matrix, the cross-coupling matrix being determined based on one or more signals received by the OPA PIC via the multimode fiber; and
transmitting, by the OPA PIC, the adjusted first signal to the multimode fiber.

11. The method of claim 10, wherein the one or more signals received by the OPA PIC via the multimode fiber includes a signal including signal information and a plurality of control wavelengths.

12. The method of claim 11, wherein the signal information includes a number of spatial modes.

13. The method of claim 12, wherein a number of received control wavelengths corresponds to the number of spatial modes of the signal including signal information of the one or more signals.

14. The method of claim 10, wherein adjusting, by the one or more processors of the OPA PIC, the first signal based on the cross-coupling matrix includes driving, by the one or more processors of the OPA PIC, a plurality of phase modulators and a plurality of amplitude modulators of the OPA PIC to adjust the first signal based on the cross-coupling matrix.

15. A device, the device comprising:
an optical phased array (OPA) photonic integrated circuit (PIC) configured to transmit and receive signals, the OPA PIC including one or more processors configured to:
determine a cross-coupling matrix based on a plurality of received control wavelengths, the cross-coupling matrix being indicative of errors of signals received from a multimode fiber;
adjust signals received from the multimode fiber based on the cross-coupling matrix; and
adjust signals to be transmitted from the OPA PIC based on the cross-coupling matrix.

16. The device of claim 15, wherein the errors of received signals indicated by the cross-coupling matrix include errors resulting from propagation through the multimode fiber.

17. The device of claim 15, further comprising a probe control system configured to generate and receive signals including signal information.

18. The device of claim 17, wherein the probe control system comprising:
a laser source configured to generate signals;
a plurality of phase modulators and a plurality of amplitude modulators configured adjust the phase and amplitude of signals passing therethrough; and
a plurality of photodiodes operatively coupled to the plurality of phase modulators and the plurality of amplitude modulators, the plurality of photodiodes configured to at least one of phase, amplitude, and polarization of signals.

19. The device of claim 15, further comprising a signal control system configured to generate and receive a plurality of control wavelengths.

20. The device of claim 19, wherein the signal control system includes:
a laser source configured to generate control wavelengths;
a plurality of phase modulators and a plurality of amplitude modulators configured adjust the phase and amplitude of signals passing therethrough; and
a plurality of photodiodes operatively coupled to the plurality of phase modulators and the plurality of amplitude modulators, the plurality of photodiodes configured to at least one of phase, amplitude, and polarization of signals.
